(19) United States
(12) Patent Application Publication
(10) Pub. No.: US 2016/0012157 A1
(43) Pub. Date: Jan. 14, 2016

(54) APPARATUS AND METHOD FOR EXTRAPOLATING OBSERVED SURFACES THROUGH OCCLUDED REGIONS

(71) Applicants: Kevin WILLIAMS, (US); Lesa WILLIAMS, Marshall, VA (US); Jim WILLIAMS, Tremonton, UT (US)

(72) Inventors: Kevin S. WILLIAMS, Marshall, VA (US); Lesa S. WILLIAMS, Marshall, VA (US); Jim B. WILLIAMS, Tremonton, UT (US)

(73) Assignee: ClearEdge3D, Inc,, Manassas, VA (US)

(21) Appl. No.: 14/771,396

(22) PCT Filed: Feb. 28, 2014
(86) PCT No.: PCT/US14/19371

§ 371 Date: Aug. 28, 2015

Related U.S. Application Data
(60) Provisional application No. 61/770,619, filed on Feb. 28, 2013.

(51) Int. Cl. G06F 17/50

(52) U.S. Cl. CPC G06F 17/50

(57) ABSTRACT

The presently disclosed embodiments may include a system for constructing a virtual 3D model of one or more objects within a scene, where the virtual 3D model contains one or more wholly or partially unobserved faces. In some embodiments the system may include at least one processing device configured to: receive, through a data interface, data describing a set of measurements of observed portions of the one or more objects in the scene; construct a preliminary 3D model, based on data received via the data interface, describing observed portions of the scene; generate an extension line network, based on the preliminary 3D model, describing unobserved portions of the one or more objects in the scene; construct at least one face associated with a wholly or partially unobserved portion of the one or more objects in the scene, based on the extension line network and the preliminary 3D model; and construct the virtual 3D model using the preliminary 3D model, which describes observed portions of the one or more objects in the scene, and the at least one constructed face associated with the wholly or partially unobserved portion of the one or more objects in the scene.

### CROSS-REFERENCE TO RELATED APPLICATIONS

This application claims priority to U.S. Provisional Patent Application Ser. No. 61/770,619, filed Feb. 28, 2013, entitled, “APPARATUS AND METHOD FOR EXTRAPOLATING OBSERVED SURFACES THROUGH OCCLUDED REGIONS”, the contents of which are incorporated herein by reference.

### FIELD OF THE INVENTION

The present invention relates generally to the field of machine perception and more particularly to calculating probable positions in three dimensions of occluded faces of viewed objects.

### BACKGROUND

Civil and mechanical engineering projects, GIS (Geographical Information Systems) mapping programs, military simulations, and numerous other applications all require accurate three dimensional (3D) computer models of real-world objects.

Most prior art methods for creating 3D models involve extensive manual measurement and modeling. The measuring component may be achieved either through direct measurement (such as surveying) of the objects themselves or through measuring images of the objects using the science of photogrammetry. The modeling component typically involves manually inputting the measurements into computer modeling programs such as computer-aided design (CAD) software, GIS, or other similar solid modeling packages. This process is labor intensive and error prone.

Point cloud capture technology, such as laser scanning or automated photogrammetric stereo matching, is a relatively new technology for improving upon this 3D-modeling process. These systems scan objects or scenes to construct a “point cloud” consisting of 3D point measurements of the scene. These points can then be used to guide the process of feature extraction.

Point clouds are often plagued by the problem of occlusion, though. For example, FIG. 1 illustrates an occlusion situation where box 100 occludes a portion of box 102. The dashed lines 104 represent occluded regions, including occluded surfaces, of objects in the scene that cannot be directly viewed from the perspective of the observer 106. FIG. 2 represents the desired reconstructed model with those occluded regions filled. The problem of occlusion occurs frequently with scans of most man-made objects, and particularly with building structures.

For instance, an opaque object located between a scanner and a building facade will block the scanner's view of the facade and create an occluded region in the scan of the building. Objects may even be self-occluding, as in the case of a portico obscuring portions of the facade directly behind the portico. Even a simple six-sided box, unless scanned from multiple perspectives, will have at most three sides visible, with the other three being self-occluded.

One common way to deal with occlusions in scanned data is to scan the scene from multiple viewpoints and combine the data from the individual scans using a process called registration. Though multiple scans may solve some of the occlusion issues, it is usually impractical to obtain sufficient scans to observe all surfaces in a complex scene.

### BRIEF DESCRIPTION OF FIGURES

FIG. 1 illustrates one object being occluded by another object from the perspective of a scanning or imaging device, in accordance with one embodiment of the present invention.

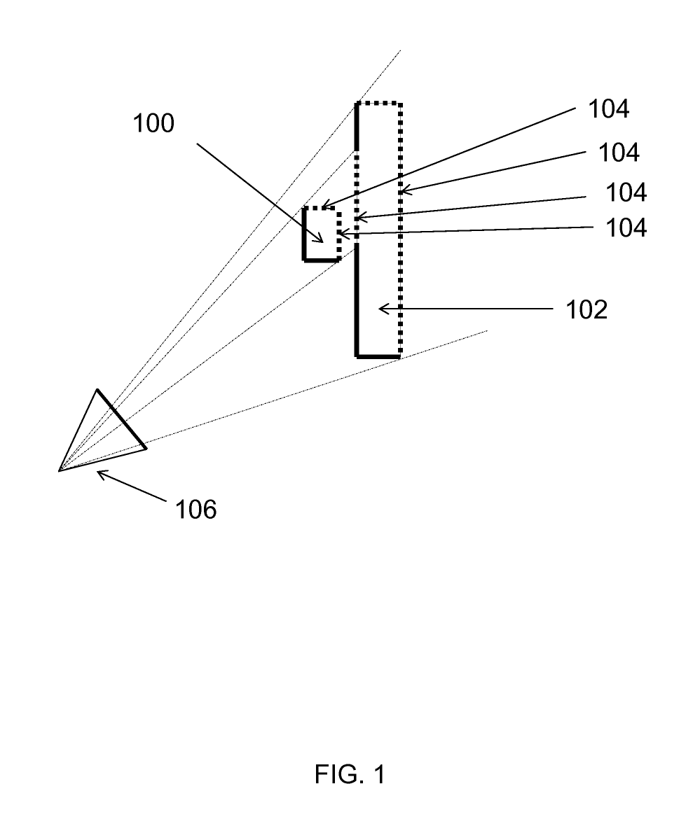

FIG. 2 illustrates the desired reconstructed objects observed in FIG. 1, in accordance with one embodiment of the present invention.

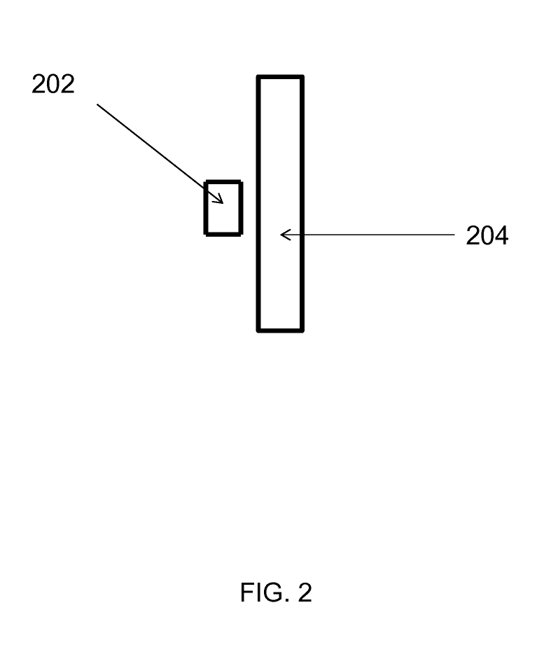

FIG. 3 illustrates a computer configured in accordance with one embodiment of the present invention.

FIG. 4 is a flowchart illustrating processing operations for reconstructing one or more unobserved faces in a 3D model, in accordance with one embodiment of the present invention.

FIG. 5 illustrates the process of stitching two adjacent faces together, in accordance with one embodiment of the present invention.

FIG. 6 illustrates the effects of occlusion on 3D bodies and shows how unreal edges are observed on the faces of occluded objects, in accordance with one embodiment of the present invention.

FIG. 7 illustrates one way to detect occlusions in range data by finding large discontinuities between adjacent measurements, in accordance with one embodiment of the present invention.

FIG. 8 illustrates principles guiding the inference of occluded geometry, in accordance with one embodiment of the present invention.

FIG. 9 illustrates extending observed edges through occluded regions using extension lines, and shows how they can connect with each other through intersection or through a parallel connection, in accordance with one embodiment of the present invention.

FIG. 10 illustrates extending an observed edge through an occluded region using an extension line, and shows how it can connect with a face, in accordance with one embodiment of the present invention.

FIG. 11 illustrates how an intersecting connection between two extension lines can form a new third extension line, in accordance with one embodiment of the present invention.

FIG. 12 illustrates how intersecting an extension line with a face can form two new extension lines, in accordance with one embodiment of the present invention.

FIG. 13 illustrates topologically valid extension line connections, in accordance with one embodiment of the present invention.

FIG. 14 illustrates topologically invalid extension line connections, in accordance with one embodiment of the present invention.

FIG. 15 illustrates convex and concave edges, in accordance with one embodiment of the present invention.

FIG. 16 is a flowchart showing the iterative process of connecting extension lines and completing the extension line network to form a 3D model, in accordance with one embodiment of the present invention.

### DETAILED DESCRIPTION

One or more embodiments provide a method of and apparatus for using observed faces to estimate geometry in occluded regions. Various features associated with the operation of embodiments of the present invention will now be set forth. Prior to such description, a glossary of terms applicable for some embodiments is provided.

Scene: According to some embodiments, a scene may include or refer to a set of one or more physical objects.

Boundary representation model: According to some embodiments, a boundary representation model may rely on the mathematical property that a filled-in geometric D-dimensional region is completely specified if one specifies the (D-1)-dimensional boundary of that region and specifies which side of the boundary the filled-in region is. So the shape of a 3D object is specified by specifying the (2D) faces in 3D space that form its boundary. Similarly, the 2D faces can be specified by specifying a 2D surface geometry (such as a plane or a cylinder) and a 1D surface boundary lying upon the surface geometry (such as the four sides of a rectangle). This 1D surface boundary can be described as a collection of 1D edges, which can be specified as a 1D edge geometry lying upon the surface geometry and a pair of end vertices (if the edge is an open set, such as a line segment) or an empty set of vertices (if the edge is a closed set, such as a circle, for which the boundary is by definition empty). According to some embodiments, the concept of edge, surface, and vertex geometries are generalized to include a thickness, so that, e.g., an edge geometry consists of a thin tube of points centered on a central 1D curve. These methods of representing geometry are utilized by solid modeling kernels such as ACIS, and are familiar to a person of ordinary skill in the art.

Extending a surface: According to some embodiments, extending a surface may refer to the act of modifying a surface description by changing the description of the surface boundary to include additional regions of the surface and extending the surface geometry, if necessary.

Face: According to some embodiments, a face may refer to a two-dimensional element of the boundary of a solid model. The geometry of a particular face is typically defined as a connected two-dimensional subset of a particular surface on the boundary of the solid model. Adjacent faces are typically separated by a collection of edges and/or vertices. For example, each face of a cube is a square.

3D Model: According to some embodiments, a 3D Model may describe a set of points in a 3D space. In some embodiments, this can be a collection of one or more faces that describe the boundary or a portion of the boundary of a set of one or more objects. For example, a 3D model that contains the top and bottom faces of a cube would be a 3D model that describes a portion of the boundary of the cube. Similarly, a 3D model that contains all six faces of a cube would be a 3D model that describes the (entire) boundary of the cube. In some embodiments, faces that describe adjacent portions of the boundary of an object are stitched together, meaning that their face boundaries share one or more edges and/or vertices.

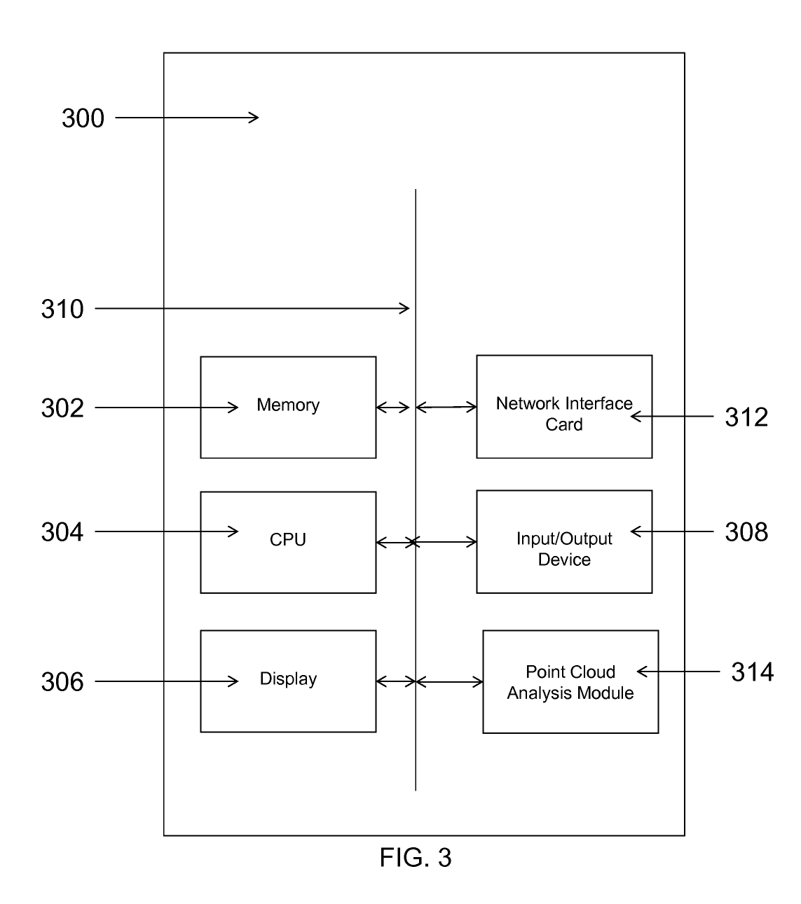

Virtual 3D Model: According to some embodiments, a virtual 3D Model may include a set of data, residing in a memory 302 of a computer system 300 as illustrated in FIG. 3, that describes a 3D Model.

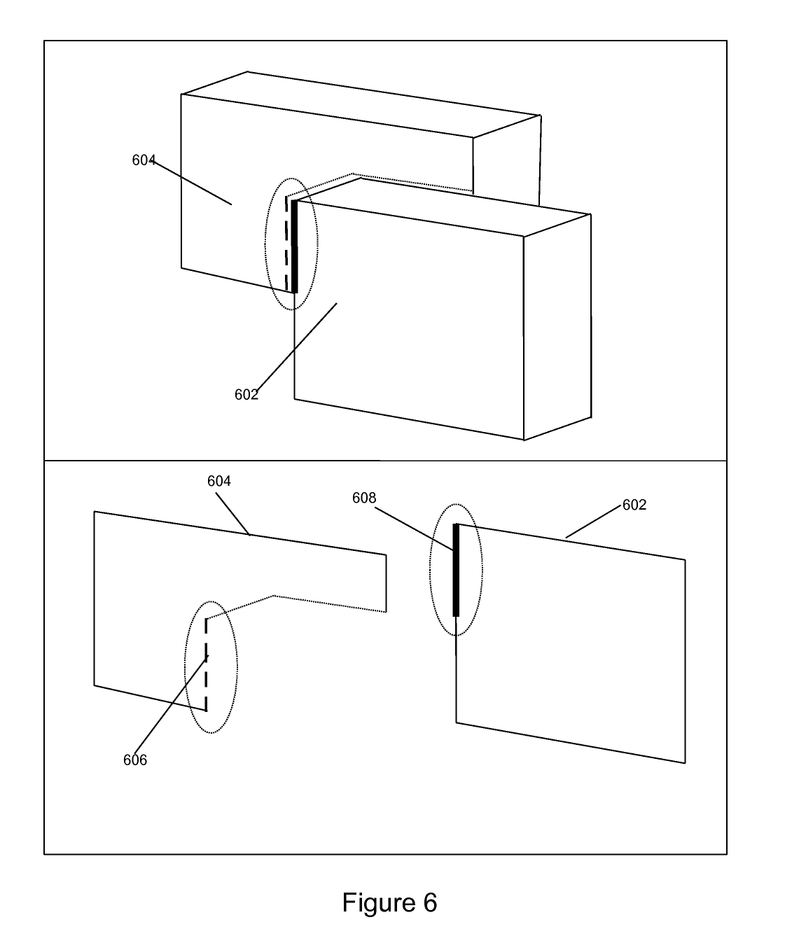

Real/unreal edges: According to some embodiments, real edges in an observed model may include physical edges formed by the intersection of two different actual surfaces. Because these are physically a part of the model and not merely an artifact of the act of observation, they are called real edges. According to some embodiments, edges in an observed model may be artificially formed at the limits of the observation by occluding objects. Because these edges are not physically present in the object but are merely artifacts of the act of observation, they are called unreal edges. In this system, each observed edge may be classified as real or unreal. FIG. 6 illustrates this principle. Edge 608 is a real edge; edge 606 is an unreal edge.

Extension line: According to some embodiments, an extension line may include an artificial construct of the system to extend model edges through occluded regions. In some embodiments, an extension line starts at a vertex of the model and extends in a given direction until it intersects either another extension line or a face of the model. In some embodiments, an extension line is comprised of a direction of travel as well as two bordering faces.

Unconnected Extension Line: According to some embodiments, an unconnected extension line is a non-terminated line constructed to extend a model edge in a specified direction until it connects with another feature in the model.

Completing the extension line network: According to some embodiments, completing the extension line network may refer to the act of extending all of the constructed extension lines in a scene until they connect with other extension lines or other faces.

Data Interface: According to some embodiments, a data interface may include a portion of a computer system that allows data to be loaded onto the computer system. In some embodiments a Network Interface Card 312 may operate as a data interface, allowing data to be loaded across a network. In some embodiments, an input/output device may operate as a data interface. In some embodiments, a removable memory device or removable memory media may operate as a data interface, allowing data to be loaded by attaching the device or by loading the media. This list of embodiments is not exclusive; other forms of a data interface may appear in other embodiments.

The following paragraphs describe one or more embodiments in terms of extrapolating planar regions within a point cloud consisting of data from collected from one or more viewpoints, but the same process may be used to extrapolate other parametric surfaces such as cylinders, cones, etc. An objective of one or more embodiments is to extrapolate the observed surfaces of a 3D model constructed from a point cloud in order to fill in the occluded regions and estimate the hidden geometry. A method embodiment comprises aligning observed and modeled surfaces and edges so that disjoint parts line up with each other in a coplanar or collinear fashion.

The method further comprises distinguishing real observed edges from unreal, occluded edges in the model. The method further comprises extending real, observed edges through occluded regions until they join or intersect other edges or surfaces. The method further comprises extending any edge along trajectories established by observed surfaces until they join or intersect other edges or surfaces. The method further comprises checking for topological consistency between edges before allowing joins or intersections. The method further comprises the construction of two adjacent surfaces on each side of every observed edge within a scanned dataset, from which additional edges are constructed. The method further comprises a graphical user interface (GUI) to allow users to guide the joining of edges. The method further comprises the use of the last-created intersection node as the starting node for the next intersection for the user-guided joining of edges. The method further comprises the optimization of only allowing coplanar surfaces and edges to join with each other. One or more embodiments of the method may be implemented in software, e.g., a set of instructions stored in a non-transitory medium for execution by a computer system, hardware, firmware, or a combination thereof.

FIG. 3 illustrates a computer system 300 configured in accordance with an embodiment of the present invention, wherein the computer system 300 is programmed, e.g., executes a set of instructions stored, for example, in memory 302, with a method according to an embodiment. The computer system 300 may include any components suitable for use in 3D modeling. The computer system 300 may include one or more of various components, such as a memory 302, a central processing unit (CPU) or controller 304, a display 306, input/output devices 308, or a bus 310. The bus 310 or another similar communication mechanism may transfer information between the components of the computer system, such as a memory 302, CPU 304, display 306 or input/output devices 308. The memory 302, which may include a volatile and/or a non-volatile memory, may store a set of instructions to be executed by the CPU 304. The memory 302 also may be used for storing temporary variables or other intermediate information during execution of instructions to be executed by the CPU 304. In certain embodiments, the instructions to be executed by the CPU 304 may be stored in a non-volatile portion of the memory 302. In certain embodiments, the instructions for causing a processor device 304 and computer system 300 to perform the described steps and tasks can be located in memory 302. These instructions, however, can also be loaded from a disk or retrieved from a remote location. In some embodiments, the instructions may reside on a server, and they can be accessed and/or downloaded from the server via a data connection with the data interface. The data connection may include a wired or wireless communication path established with the Internet, for example.

In certain embodiments, a Network Interface Card (NIC) 312 may be included in the computer system 300, and might provide connectivity to a network (not shown), thereby allowing the computer system 300 to operate in a networked environment. In certain embodiments, data such as measurements that describe portions of a scene may be received through the NIC 312 and/or the input/output devices 308.

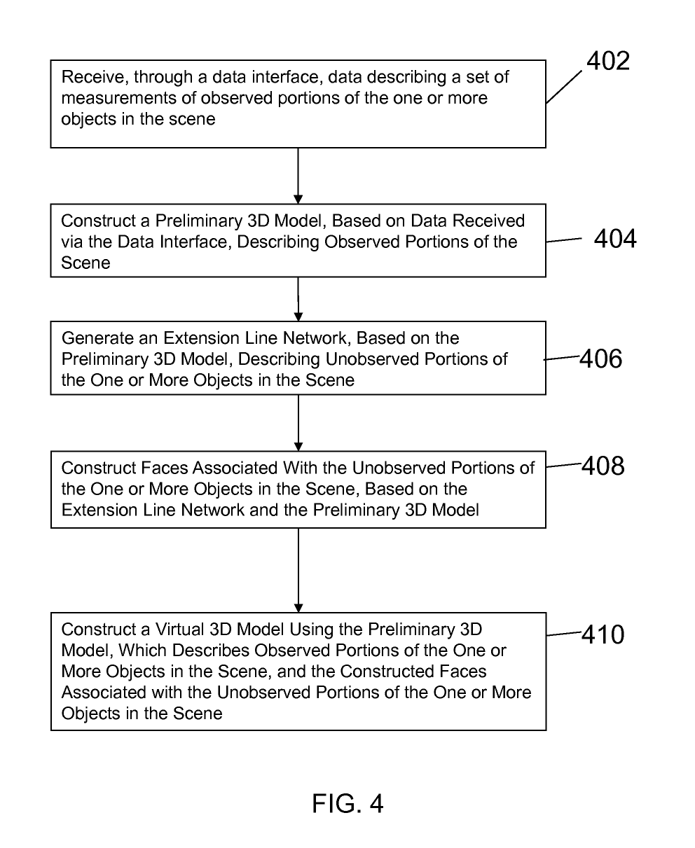

In certain embodiments, the memory 302 may include one or more executable modules to implement operations described herein. In one embodiment, the memory 302 may include a Point Cloud Analysis module 314. In one embodiment, the Point Cloud Analysis module 314 may include EdgeWise™ which is commercially available from ClearEdge 3D, Manassas, Va. In a particular embodiment, the Point Cloud Analysis module 314 may also include executable instructions to automatically reconstruct one or more surfaces in a 3D model of a scene. The operations performed by the Point Cloud Analysis module 314 are discussed in greater detail in FIG. 4 below.

It should be noted that the Point Cloud Analysis module 314 is provided by way of example. Additional modules, such as an operating system or graphical user interface module may also be included. It should be appreciated that the functions of the modules may be combined. In addition, the functions of the modules need not be performed on a single machine. Instead, the functions may be distributed across a network, if desired. Indeed, certain embodiments of the invention are implemented in a client-server environment with various components being implemented at the client-side and/or server-side.

The CPU 304 may process information and instructions, e.g., stored in memory 302 according to at least some embodiments.

In at least some embodiments, the computer system 300 may further comprise a display 306, such as a liquid crystal display (LCD), cathode ray tube (CRT), or other display technology, for displaying information to a user. In at least some embodiments, a display 306 is not included as a part of computer system 300. In at least some further embodiments, the computer system 300 may be configured to be removably connected with the display 306.

In at least some embodiments, the memory 302 may comprise a static and/or a dynamic memory storage device such as a hard drive, optical and/or magnetic drive, etc. for storing information and/or instructions. In at least some further embodiments, a static and/or dynamic memory storage device and/or media 302 may be configured to be removably connected with the computer system 300. In at least some further embodiments, data such as measurements that describe portions of a scene may be received by loading a removable media onto to appropriate device 302, for example by placing an optical disk into an optical drive, a magnetic tape into a magnetic drive, etc. In at least some other further embodiments, data such as measurements that describe portions of a scene may be received by attaching a removable static and/or dynamic memory storage device 302, such as a hard drive, optical, and/or magnetic drive, etc. to the computer system 300.

FIG. 4 is a flowchart illustrating processing operations for constructing a virtual 3D model of one or more objects within a scene, said virtual 3D model containing one or more wholly or partially unobserved faces, in accordance with one embodiment of the invention. An exemplary set of operations (402-410) for constructing a virtual 3D model of one or more objects within a scene, said virtual 3D model containing one or more wholly or partially unobserved faces, are discussed in detail below.

Operation of Receiving, Through a Data Interface, Data Describing a Set of Measurements of Observed Portions of the One or More Objects in the Scene

An operation to receive, through a data interface, data describing a set of measurements of observed portions of the one or more objects in the scene is performed (block 402). In one embodiment, a computer system receives, through a data interface, a data set describing a set of measurements of observed portions of one or more objects in a scene. For example, a data file containing a set of one or more laser scans of a group of buildings may be loaded onto a computer system 300 through a network interface card 312 and stored in memory 302 as illustrated in FIG. 3. In one embodiment, an optical storage disk containing photogrammetric measurements of a factory might be placed in an optical disk drive.

In at least one embodiment, a point cloud of a scene is loaded into the memory 302 of a computing device 300 for processing as illustrated in FIG. 3.

It should be noted that this is not an exclusive list of embodiments of this portion of the invention, other embodiments are possible.

Operation of Constructing a Preliminary 3D Model, Based on Data Received via the Data Interface, Describing Observed Portions of the Scene

An operation to construct a preliminary 3D model, based on data received via the data interface, describing observed portions of the scene is performed (block 404). In at least one embodiment, a point cloud which was received via the data interface is first analyzed to find coplanar regions of points. For each region of points, a planar polygon may be formed to describe its boundary. These polygons may then be generalized to smooth the bounding edges and remove trivial holes using an algorithm as set forth in Douglas, D. H. and Peucker, T. K. “Algorithms for the reduction of the number of points required to represent a digitized line or its caricature”, The Canadian Cartographer 10(2), 112-122 (1973). One or more of the discovered polygons may then be “snapped” to align with each other such that almost-coplanar surfaces become exactly coplanar, almost orthogonal surfaces become exactly orthogonal, almost-collinear edges become exactly collinear with each other, and almost orthogonal edges become exactly orthogonal to each other. “Snapping” refers to the process of aligning surfaces and edges which are determined to be aligned within a tolerance amount. In at least some embodiments, this “snapping” process is performed using a clustering technique such as QT clustering to group similar plane and line parameters. The clustering of parameters as described is familiar to a person of ordinary skill in the art.

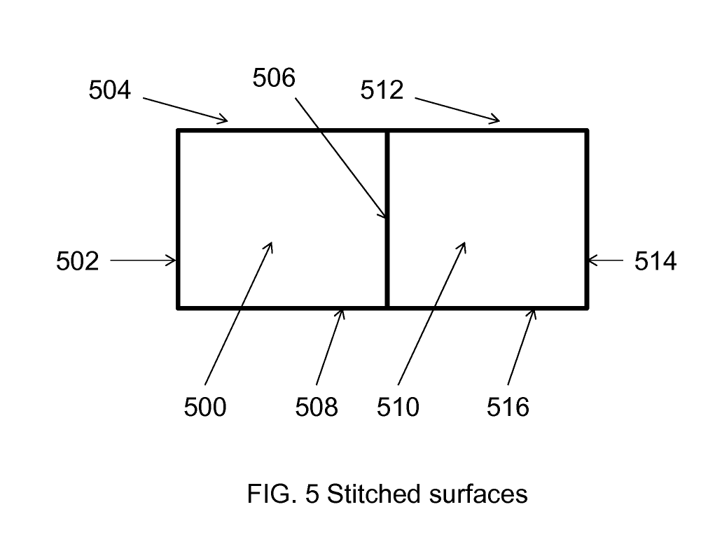

In one embodiment of the invention, faces share edges in their boundary definitions. This is illustrated in FIG. 5. The boundary of face 500 consists of edges 502, 504, 506, and 508. The boundary of face 510 consists of edges 506, 512, 514, and 516; edge 506 is an element of both boundaries. In one embodiment of the invention, such faces are said to be stitched together. By construction, faces which are stitched together are adjacent to each other; face 500 lies on one side of edge 506 and face 510 lies on the other side. In one embodiment, an edge which bounds only a single face is called “open”, while an edge that bounds two faces is called “stitched.” A common operation on a set of faces in solid modeling is stitching; in one embodiment of this operation the faces are examined for open edges which are close to coincident. When such a pair of open edges is found, the faces that they bound are modified so that they share a single edge along the coincident region. In another embodiment, new stitched faces are created and replace the original unstitched faces in the solid model. In one embodiment, the geometry of the stitched edge is obtained by intersecting the geometries of the adjacent faces. In another embodiment, the geometries of the adjacent faces are extended far enough to ensure an intersection along the coincidence region of the two open edges. In another embodiment, a thick edge geometry is used.

In at least one embodiment, these resulting faces and stitched edges are accumulated into one model to form the preliminary 3D model.

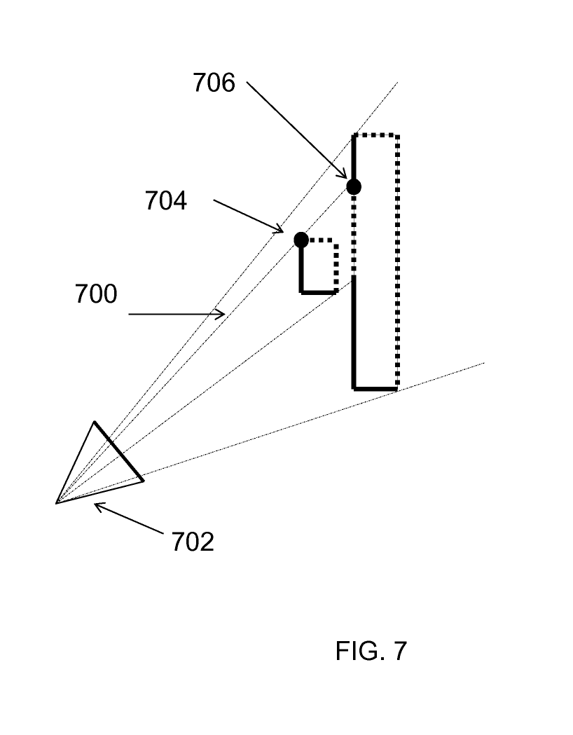

In order to extrapolate the observed faces through occluded regions, one must know where the observed faces stop and the occluded regions begin. This information is computed from the geometry between the scanner location and the objects in the scene. FIG. 6 shows a scene with objects represented by simple block geometry from the perspective of a scanner, where face 602 of the front block occludes face 604 of the back block. The lower half of FIG. 6 illustrates that same scene with 602 moved away to depict the unreal, occluded edges 606 of face 604. In the present embodiment, these unreal edges are detected and ignored, while the real edges are used to extrapolate the faces through these occluded regions. In at least one embodiment, these unreal, occluded edges are detected at significant discontinuities, in the distance measurements between the scanner and the scanned faces. FIG. 7 illustrates the detection of a discontinuity by measuring the jump between point 704 and 706. Finally, each edge of every polygon in the preliminary model is then labeled as real or unreal.

In at least one embodiment, the resulting model may be a polyhedral model. In such an embodiment, each vertex (or corner) in the observed model borders at least 3 intersecting faces (whether those faces are observed or not) and at least 3 intersecting edges (whether those edges are observed or not). Additionally, each edge may border exactly two faces (whether those faces are observed or not).

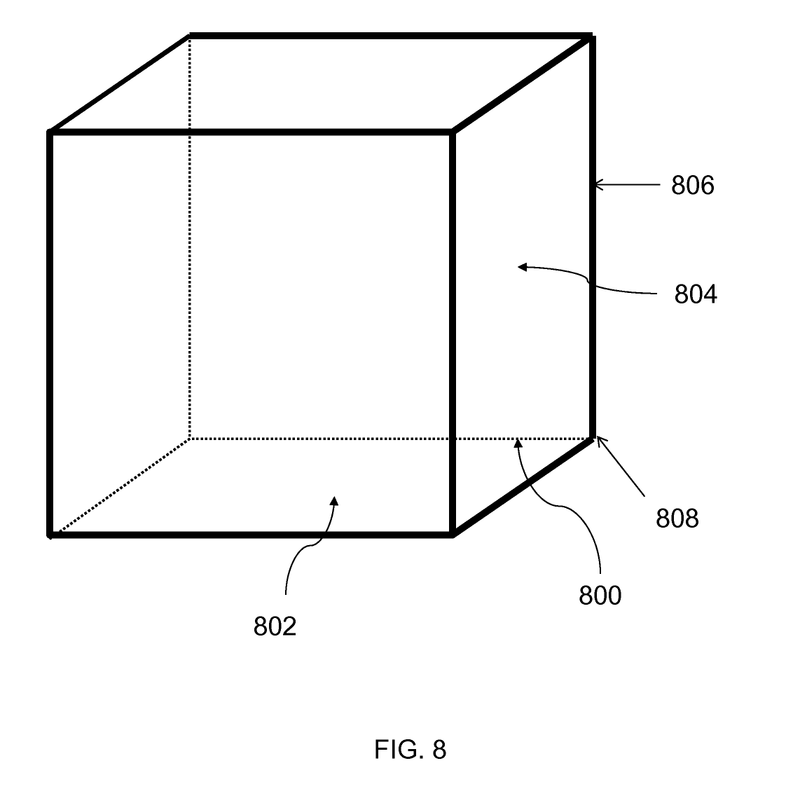

Entire faces are often missing from scanned data, but the faces (or in some embodiments, the portion of faces) may be inferred using the topological rules laid out above. FIG. 8 illustrates inferable edges and faces for a cube. FIG. 8 shows how these topological rules may be used to infer completely occluded faces and edges. Because edge 806 only touches one observed face, the existence of the back face 804 may be inferred. Because vertex 808 only touches two observed edges, the existence of hidden edge 800 may be inferred. Additionally, because vertex 808 only touches one observed face, both the back face 804 and the bottom face 802 may be inferred. In at least one embodiment, each real edge in the model is associated with two bordering faces. If the real edge borders two observed faces, those are used. If it borders only one observed face, another face is created that satisfies the conditions of being coplanar with the edge and perpendicular to the observed face. The perpendicularity condition is convenient but not required; other embodiments could choose an angle other than ninety degrees between the hidden plane's normal and the normal of the observed face. This newly created face is then associated with the edge. This newly created face constitutes a wholly unobserved face. In at least one embodiment, these newly created faces constituting wholly unobserved faces are added to the preliminary model. At this stage, the preliminary model contains sufficient geometric information to generate the extension line network.

Operation of Generating an Extension Line Network, Based on the Preliminary 3D Model, Describing Unobserved Portions of the One or More Objects in the Scene

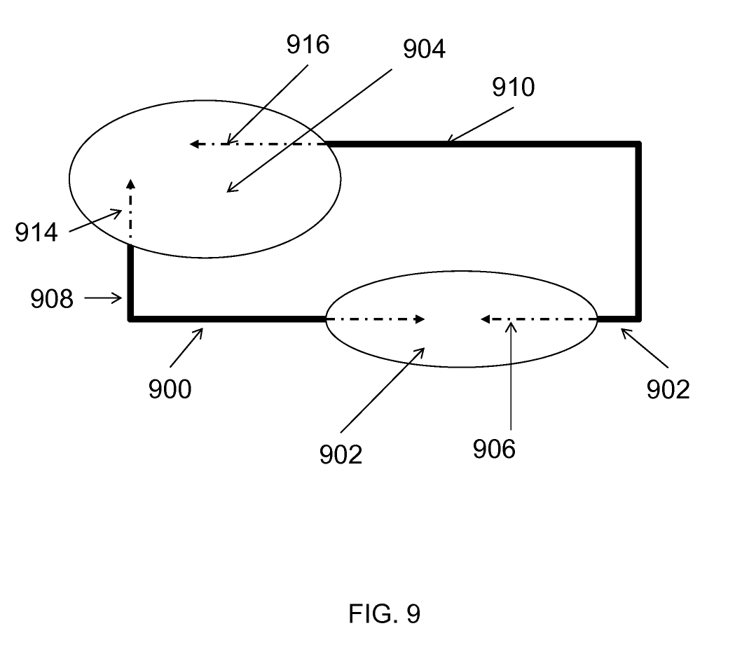

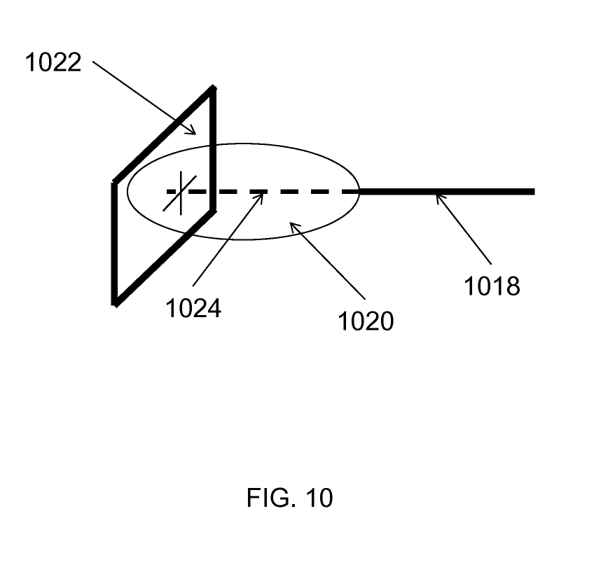

An operation to generate an extension line network, based on the preliminary 3D model, describing unobserved portions of the one or more objects in the scene is then performed. In one or more embodiments, the initial model of the observed faces is analyzed to obtain a set of extension lines 406 (FIG. 4). Extension lines are formed from incomplete vertices to extend face edges and complete the 3D model. These extension lines are used to extend edges in the appropriate direction into unobserved regions of space and connect with other extension lines FIG. 9 as well as with other model faces FIG. 10. Extension lines are considered to be incomplete until they connect to either another extension line or to a face. Once an extension line connects to another extension line or to a face, it is considered complete, and it can then be converted into a real edge of the model and used to form part of the boundary of the two bordering faces. In this manner, extension lines provide a mechanism for inferring, bounding, and constructing wholly unobserved faces.

In one or more embodiments, each vertex is examined to determine if it is a complete vertex. A complete vertex borders three faces and three real edges or completed extension lines. Incomplete vertices border fewer than three real edges or completed extension lines. Extension lines may be formed at incomplete vertices and used to extend the model through occluded regions.

In one or more embodiments, an extension line is formed at vertices with only one real edge and one or more unreal edges, and this extension line is created such that it continues tangentially from the end of the real edge, effectively extending the two faces that border that real edge. These vertices are unreal vertices formed by the artifact of occlusion rather than actual corners of a physical object, and will be discarded in the final model.

In one or more embodiments, an extension line is also formed at vertices which border only two real edges. By definition, these two real edges that intersect will always share one face that they each border. Each of the two real edges will also border an unshared face. The new extension line is formed such that it starts at the vertex and travels along the intersection of the two unshared faces.

Operation of Constructing Faces Associated With the Unobserved Portions of the One or More Objects in the Scene, Based on the Extension Line Network and the Preliminary 3D Model

An operation to construct faces associated with the unobserved portions of the one or more objects in the scene, based on the extension line network and the preliminary 3D model may then be performed (block 408). In at least one embodiment, this operation is performed to construct at least one face associated with a wholly unobserved portion of the one or more objects in the scene. In at least one other embodiment, this operation is performed to construct at least one face associated with a wholly or partially unobserved portion of the one or more objects in the scene. In at least one embodiment, constructing faces associated with the unobserved portions of the one or more objects in the scene includes completing the extension line network, then combining the extension line network with edges in the preliminary 3D model to form a set of faces associated with the unobserved portions of the one or more objects in the scene. Once appropriate extension lines have been formed at some or all of the initial model vertices, these extension lines are extended to intersect and connect both with each other as well as with model faces. Once an extension line connects to another component, it is considered complete, and it is converted into a real edge of the model. In this fashion, the model is extrapolated through unobserved regions of space to complete each edge and face of the model.

Extension lines may extend and connect with other extension lines or faces in at least one of three different ways: as a parallel join 902 and 904, as an intersecting join 906 and 908, as in FIG. 9, or as a join with a solid face 1002, as in FIG. 10.

When an extension line connects with a collinear, opposite-facing extension line, no new vertex is created, but both extension lines become complete and extend to each other's point of origin, and can then be replaced with a real edge. FIG. 9 illustrates this phenomenon, where extension line 902 intersects with extension line 904.

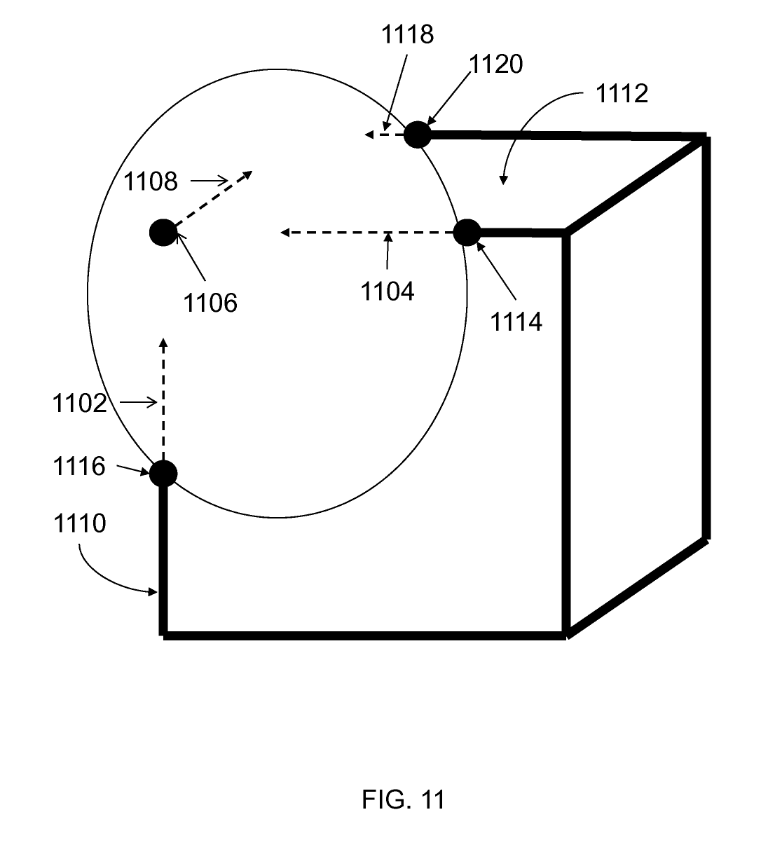

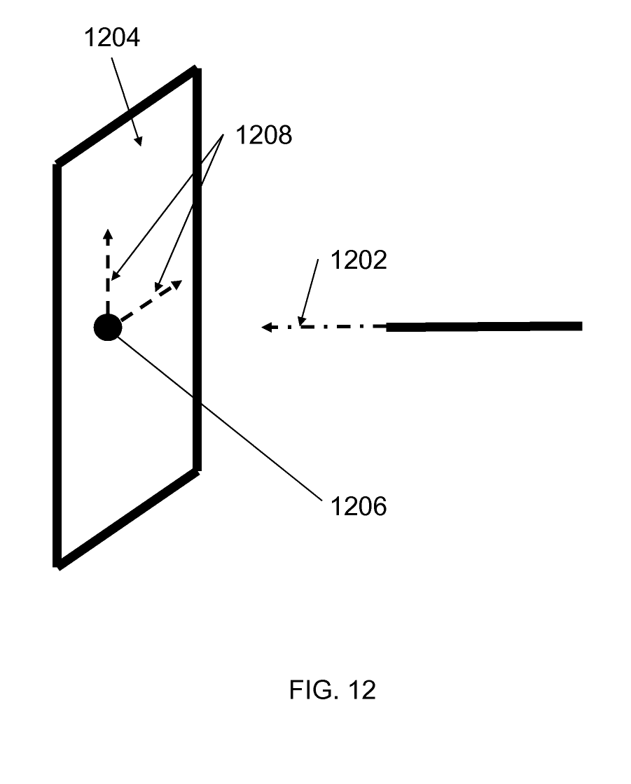

When an extension line connects with a second intersecting extension line, a new vertex is created for the model. In this case, both extension lines become complete, and a new extension line is created at the vertex to extend along the intersection of the two unshared planes from the original extension line. FIG. 11 illustrates this process. When extension lines 1102 and 1104 connect, they form new vertex 1106, and they also create new extension line 1108 extending along the intersection of planes 1110 and 1112. When an extension line connects with a face, a new vertex is created for the model as well. In this case, the extension line becomes complete, and two new extension lines are created at the vertex to extend along the intersections of that face with each of the planes associated with the newly complete extension line. FIG. 12 shows extension line 1202 connecting with face 1204 and forming a new vertex 1206 and new extension lines 1208.

In one or more embodiments, all thusly formed extension lines are added to the model, and the extension lines are iteratively paired with each other and connected until the entire extension line network has been completed.

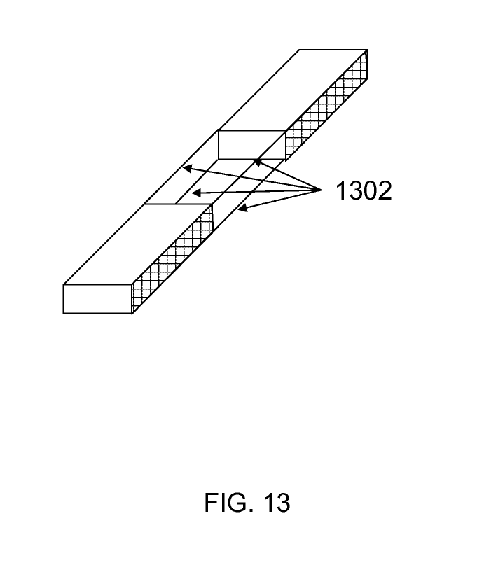

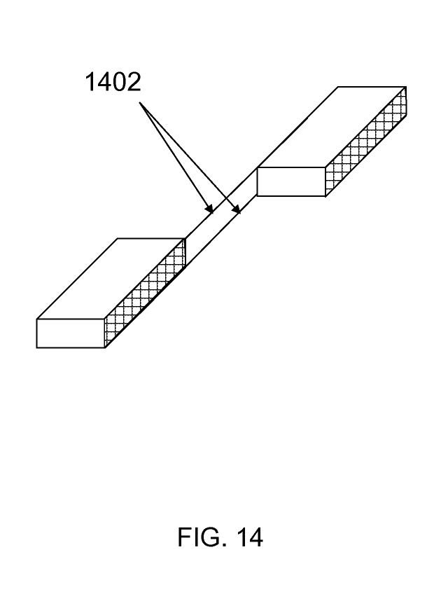

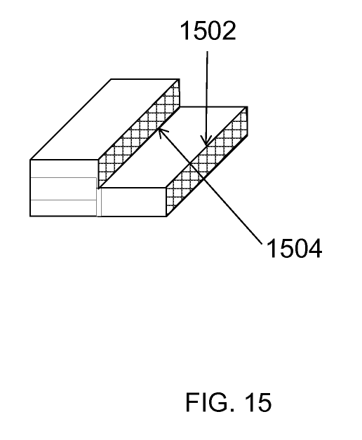

In one or more embodiments, the connections between extension lines may be constrained by 3D topological rules to prevent joining two topologically incompatible edges from connecting with each other. FIG. 13 illustrates valid topological joins 1302, while FIG. 14 illustrates topologically invalid joins 1402. Invalid joins are defined as joins that create infeasible 3D faces. If an edge is defined as falling on the intersection of two planes, then the validity of any join is determinable by a person of ordinary skill in the art by analyzing the normals of the two planes and the convexity 1502 or concavity 1504 of each edge (FIG. 15).

In one or more embodiments, the process of selecting between multiple possible connections between extension lines may be optimized using different scoring metrics. These metrics may include factors such as the resulting length of completed extension lines, complexity of the resulting model, number of completed extension lines, number of faces completely bounded by both real edges and completed extension lines, etc.

In at least one embodiment, the edges may be automatically, semi-automatically (user-assisted), or manually joined to complete the surface models.

In at least one embodiment of the present invention, a Graphical User Interface (GUI) is provided to allow a user to connect the edges. A user may select one edge to extend 1102, and then select either another extendable edge 1104 to join the two edges and create a new vertex 1106 with potentially a new implied edge 1108. Alternatively, a user may select an edge 1202 and then select a planar face 1204 with which to intersect the first edge. In another embodiment, a GUI may allow a user to select the edges by first selecting a vertex that the edge attaches to (for instance, selecting 1114 and joining with vertex 1116).

Additionally, in at least one embodiment of the present invention incorporating a manual GUI interface for joining edges, the intersection point of the last join operation creates a new “Implied edge”, which becomes the selected, starting edge for the next manual joining process. For example, joining 1102 with 1104 creates 1108, which would then be automatically selected for the next join with 1118. In another embodiment, joining vertex 1114 with vertex 1116 would create vertex 1106, which would then be automatically selected for the next join with vertex 1120. In at least some of the embodiments of the present invention, this will cut the number of selections required by a human operator and allow more rapid, intuitive joining of edges.

In at least one embodiment of the present invention incorporating a manual GUI for joining edges, after selecting the first edge, only edges and faces capable of forming valid joins will be selectable as the second joining object. One example of a simple constraint in this process involves requiring joined edges to share at least one face. Enforcing topological consistency in this fashion may guide the user to select and create correct joins more quickly.

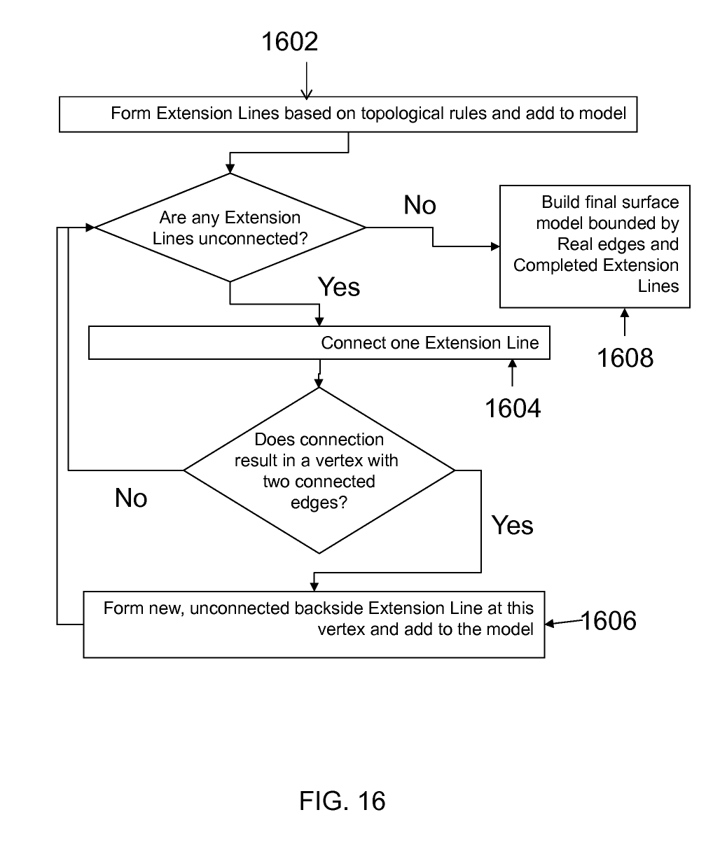

FIG. 16 gives an overview of at least one embodiment of the process of completing the extension line network. Initial extension lines are created at the vertices of the observed faces, and these are added to the model 1602. One by one, each extension line is connected 1604, whether automatically or through a manual GUI. If those connections form new extension lines, these are added to the model 1606. Once all extension lines have been connected, they are replaced with real edges, and all bounded faces are constructed 1608 to form the resulting model.

In at least one embodiment, after the extension line network has been completed, the extension lines are used to construct new faces. Because extension lines are only constructed in unobserved regions, the two faces associated with an extension line will represent partially or wholly unobserved regions of the objects in the scene.

In at least one embodiment, faces are constructed from extension lines by, for each completed extension line, constructing an edge that spans the extent of the extension line plus any real edges to which it is tangent. For every plane connected to one or more extension lines, one or more faces are created by aggregating connected extension lines and real edges which form distinct boundaries.

Operation of Constructing a Virtual 3D Model Using the Preliminary 3D Model, Which Describes Observed Portions of the One or More Objects in the Scene, and the Constructed Faces Associated with the Unobserved Portions of the One or More Objects in the Scene.

An operation to construct a virtual 3D model using the preliminary 3D model, which describes observed portions of the one or more objects in the scene, and the constructed faces associated with the unobserved portions of the one or more objects in the scene is then performed (block 410). In at least one embodiment, a final virtual 3D model is constructed by merging the constructed wholly unobserved faces, the constructed partially observed faces, and the fully observed initial faces of the model. In some embodiments, this final virtual 3D model is stored in a non-volatile memory component 302 of the computer system 300, resulting in a change to the memory component.

Completing the unscanned portions of a model remains as a hurdle for automated or semi-automated modeling of scanned scenes. A robust method for modeling these unobserved surfaces is believed provided in one or more of the present embodiments in order for automated feature extraction to become an economically attractive alternative for large-scale applications.

The presently disclosed embodiments may include a system for constructing a virtual 3D model of one or more objects within a scene, where the virtual 3D model contains one or more wholly unobserved faces. In some embodiments the system may include at least one processing device configured to: receive, through a data interface, data describing a set of measurements of observed portions of the one or more objects in the scene; construct a preliminary 3D model using data received via the data interface, describing observed portions of the scene; generate an extension line network, based on the preliminary 3D model, describing unobserved portions of the one or more objects in the scene; construct at least one face associated with a wholly unobserved portion of the one or more objects in the scene, based on the extension line network and the preliminary 3D model; and construct the virtual 3D model using the preliminary 3D model, which describes observed portions of the one or more objects in the scene, and the at least one constructed face associated with the wholly unobserved portion of the one or more objects in the scene.

The presently disclosed embodiments may also provide a method for constructing a virtual 3D model of one or more objects within a scene, said virtual 3D model containing one or more wholly unobserved faces. In some embodiments the method may include the steps of receiving, through a data interface, data describing a set of measurements of observed portions of the one or more objects in the scene; constructing a preliminary 3D model, based on data received via the data interface, describing observed portions of the scene; generating an extension line network, based on the preliminary 3D model, describing unobserved portions of the one or more objects in the scene constructing at least one face associated with a wholly unobserved portion of the one or more objects in the scene, based on the extension line network and the preliminary 3D model; and constructing the virtual 3D model based on the preliminary 3D model, describing observed portions of the one or more objects in the scene, and the at least one constructed face associated with the wholly unobserved portion of the one or more objects in the scene. The presently disclosed embodiments may also provide a computer persistent storage medium comprising executable instructions for performing the steps of the method.

The presently disclosed embodiments may also include a system for constructing a virtual 3D model of one or more objects within a scene, where the virtual 3D model contains one or more wholly or partially unobserved faces. In some embodiments the system may include at least one processing device configured to: receive, through a data interface, data describing a set of measurements of observed portions of the one or more objects in the scene; construct a preliminary 3D model, based on data received via the data interface, describing observed portions of the scene; generate an extension line network, based on the preliminary 3D model, describing unobserved portions of the one or more objects in the scene; construct at least one face associated with a wholly or partially unobserved portion of the one or more objects in the scene, based on the extension line network and the preliminary 3D model and the rules of 3D topological consistency; construct the virtual 3D model based on the preliminary 3D model, describing observed portions of the one or more objects in the scene, and the at least one constructed face associated with the wholly or partially unobserved portion of the one or more objects in the scene

The presently disclosed embodiments may also provide a method for constructing a virtual 3D model of one or more objects within a scene, where the virtual 3D model contains one or more wholly or partially unobserved faces. In some embodiments the method may include the steps of receiving, through a data interface, data describing a set of measurements of observed portions of the one or more objects in the scene; constructing a preliminary 3D model, based on data received via the data interface, describing observed portions of the scene; generating an extension line network, based on the preliminary 3D model, describing unobserved portions of the one or more objects in the scene; constructing at least one face associated with a wholly or partially unobserved portion of the one or more objects in the scene, based on the extension line network and the preliminary 3D model and the rules of 3D topological consistency; constructing the virtual 3D model based on the preliminary 3D model, describing observed portions of the one or more objects in the scene, and the at least one constructed face associated with the wholly or partially unobserved portion of the one or more objects in the scene. The presently disclosed embodiments may also provide a computer persistent storage medium comprising executable instructions for performing the steps of the method.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

1. A method for constructing a virtual 3D model of one or more objects within a scene, said virtual 3D model containing one or more wholly-unobserved faces, said method comprising the steps of:
a. receiving, through a data interface, data describing a set of measurements of observed portions of the one or more objects in the scene;
b. constructing a preliminary 3D model, based on data received via the data interface, describing observed portions of the scene;
c. generating an extension line network, based on the preliminary 3D model, describing unobserved portions of the one or more objects in the scene;
d. constructing at least one face associated with a wholly unobserved portion of the one or more objects in the scene, based on the extension line network and the preliminary 3D model; and
e. constructing the virtual 3D model using the preliminary 3D model, which describes observed portions of the one or more objects in the scene, and the at least one constructed face associated with the wholly unobserved portion of the one or more objects in the scene.

2. The method of claim 1, wherein the received measurement data includes location data for one or more of the devices used to perform the measurements and the step of generating an extension line network is also based on said location data.

3. The method of claim 2, wherein the constructed faces and the preliminary 3D model satisfy the rules of 3D topological consistency amongst themselves.

4. The method of claim 2, wherein the constructed faces are polygonal.

5. The method of claim 2, wherein the step of generating an extension line network further comprises the sub-step of identifying unreal edges in the model based on the preliminary 3D model and/or the location data.

6. A method for constructing a virtual 3D model of one or more objects within a scene, said virtual 3D model containing one or more wholly or partially unobserved faces, said method comprising the steps of:
a. receiving, through a data interface, data describing a set of measurements of observed portions of the one or more objects in the scene;
b. constructing a preliminary 3D model, based on data received via the data interface, describing observed portions of the scene;
c. generating an extension line network, based on the preliminary 3D model, describing unobserved portions of the one or more objects in the scene;
d. constructing at least one face associated with a wholly or partially unobserved portion of the one or more objects in the scene, based on the extension line network and the preliminary 3D model and the rules of 3D topological consistency;
e. constructing the virtual 3D model using the preliminary 3D model, which describes observed portions of the one or more objects in the scene, and the at least one constructed face associated with the wholly or partially unobserved portion of the one or more objects in the scene.

7. The method of claim 6, wherein the received measurement data includes location data for one or more of the devices used to perform the measurements and the step of generating an extension line network is also based on said location data. The method of claim 7, wherein the constructed faces are polygonal.

8. The method of claim 7, wherein the constructed faces are polygonal.

9. The method of claim 7, wherein the step of generating an extension line network further comprises the sub-step of identifying unreal edges in the model based on the preliminary 3D model and/or the location data.

10. A system for constructing a virtual 3D model of one or more objects within a scene, said virtual 3D model containing one or more wholly unobserved faces, comprising:
at least one processing device configured to:
a. receive, through a data interface, data describing a set of measurements of observed portions of the one or more objects in the scene;
b. construct a preliminary 3D model, based on data received via the data interface, describing observed portions of the scene;
c. generate an extension line network, based on the preliminary 3D model, describing unobserved portions of the one or more objects in the scene;
d. construct at least one face associated with a wholly unobserved portion of the one or more objects in the scene, based on the extension line network and the preliminary 3D model; and
e. construct the virtual 3D model using the preliminary 3D model, which describes observed portions of the one or more objects in the scene, and the at least one constructed face associated with the wholly unobserved portion of the one or more objects in the scene.

11. The system of claim 10, wherein the received measurement data includes location data for one or more of the devices used to perform the measurements and the operation of generating an extension line network is also based on said location data.

12. The system of claim 11, wherein the constructed faces and the preliminary 3D model satisfy the rules of 3D topological consistency amongst themselves.

13. The system of claim 11, wherein the constructed faces are polygonal.

14. The system of claim 11, wherein the operation of generating an extension line network comprises the operation of identifying unreal edges in the model based on the preliminary 3D model and/or the location data.

15. A system for constructing a virtual 3D model of one or more objects within a scene, said virtual 3D model containing one or more wholly or partially unobserved faces, comprising:
at least one processing device configured to:
a. receive, through a data interface, data describing a set of measurements of observed portions of the one or more objects in the scene;
b. construct a preliminary 3D model, based on data received via the data interface, describing observed portions of the scene;
c. generate an extension line network, based on the preliminary 3D model, describing unobserved portions of the one or more objects in the scene;
d. construct at least one face associated with a wholly or partially unobserved portion of the one or more objects in the scene, based on the extension line network and the preliminary 3D model and the rules of 3D topological consistency;
e. construct the virtual 3D model using the preliminary 3D model, which describes observed portions of the one or more objects in the scene, and the at least one constructed face associated with the wholly or partially unobserved portion of the one or more objects in the scene.

16. The system of claim 15, wherein the received measurement data includes location data for one or more of the devices used to perform the measurements and the operation of generating an extension line network is also based on said location data.

17. The system of claim 16, wherein the constructed faces are polygonal.

18. The system of claim 16, wherein the operation of generating an extension line network comprises the operation of identifying unreal edges in the model based on the preliminary 3D model and/or the location data.

19. A computer readable persistent storage medium comprising executable instructions to construct a virtual 3D model of one or more objects within a scene, said virtual 3D model containing one or more wholly unobserved faces, said computer readable persistent storage medium comprising executable instructions to cause a processing device to:
a. receive, through a data interface, data describing a set of measurements of observed portions of the one or more objects in the scene;
b. construct a preliminary 3D model, based on data received via the data interface, describing observed portions of the scene;
c. generate an extension line network, based on the preliminary 3D model, describing unobserved portions of the one or more objects in the scene;
d. construct at least one face associated with a wholly unobserved portion of the one or more objects in the scene, based on the extension line network and the preliminary 3D model; and
e. construct the virtual 3D model using the preliminary 3D model, which describes observed portions of the one or more objects in the scene, and the at least one constructed face associated with the wholly unobserved portion of the one or more objects in the scene.

20. The computer readable persistent storage medium of claim 19, wherein the received measurement data includes location data for one or more of the devices used to perform the measurements and the operation of generating an extension line network is also based on said location data.

21. The computer readable persistent storage medium of claim 20, wherein the constructed faces and the preliminary 3D model satisfy the rules of 3D topological consistency amongst themselves.

22. The computer readable persistent storage medium of claim 20, wherein the constructed faces are polygonal.

23. The computer readable persistent storage medium of claim 20, wherein the operation of generating an extension line network comprises the operation of identifying unreal edges in the model based on the preliminary 3D model and/or the location data.

24. A computer readable persistent storage medium comprising executable instructions to constructing a virtual 3D model of one or more objects within a scene, said virtual 3D model containing one or more wholly or partially unobserved faces, said computer readable persistent storage medium comprising executable instructions to cause a processing device to:
a. receive, through a data interface, data describing a set of measurements of observed portions of the one or more objects in the scene;
b. construct a preliminary 3D model, based on data received via the data interface, describing observed portions of the scene;
c. generate an extension line network, based on the preliminary 3D model, describing unobserved portions of the one or more objects in the scene;
d. construct at least one face associated with a wholly or partially unobserved portion of the one or more objects in the scene, based on the extension line network and the preliminary 3D model and the rules of 3D topological consistency;
e. construct the virtual 3D model using the preliminary 3D model, which describes observed portions of the one or more objects in the scene, and the at least one constructed face associated with the wholly or partially unobserved portion of the one or more objects in the scene.

25. The computer readable persistent storage medium of claim 24, wherein the received measurement data includes location data for one or more of the devices used to perform the measurements and the operation of generating an extension line network is also based on said location data.

26. The method of claim 25, wherein the constructed faces are polygonal.

27. The computer readable persistent storage medium of claim 25, wherein the constructed faces are polygonal.
